(19) United States
(12) Patent Application Publication
(10) Pub. No.: US 2025/0218627 A1
(43) Pub. Date: Jul. 3, 2025

(54) SURGE PROTECTION ASSEMBLIES, SURGE PROTECTION MODULES, AND METHODS OF INSTALLING SURGE PROTECTION ASSEMBLIES

(71) Applicant: International Controls and Measurements Corporation, North Syracuse, NY (US)

(72) Inventors: Weidong PAN, Morganville, NJ (US); Hollis J. GMYR, Baldwinsville, NY (US)

(73) Assignee: International Controls and Measurements Corporation, North Syracuse, NY (US)

(21) Appl. No.: 18/913,586

(22) Filed: Oct. 11, 2024

Related U.S. Application Data
(60) Provisional application No. 63/590,017, filed on Oct. 13, 2023.

(51) Int. Cl. H01C 7/12; H01C 1/01; H01C 1/02; H01C 1/14

(52) U.S. Cl. CPC H01C 7/12; H01C 1/01; H01C 1/02; H01C 1/14

(57) ABSTRACT

Surge protection assemblies, each comprising an assembly housing, an assembly circuit board, a module, and conductive elements (each with a region electrically connected to a contact region of the assembly circuit board, and a region outside the assembly housing); The module comprises plural varistors inside a module housing, a module circuit board, and module terminals each with a region inside the module housing and electrically connected to circuitry on the module circuit board, and a region outside the module housing. The surge protection module is movable as a unit between an engaged arrangement (each of the terminal second regions is electrically connected to a respective terminal connection region of the surge protection assembly circuit board) and a disengaged arrangement. Also, surge protection modules, electronic assemblies each with a surge protection assembly, and methods of installing a surge protection assembly to a plurality of circuitry conductive elements.

### CROSS-REFERENCE TO RELATED APPLICATIONS

This application claims the benefit under 35 U.S.C. 119 section (e) of U.S. Provisional Patent Application No. 63/590,017, filed Oct. 13, 2023, the entirety of which is incorporated herein by reference.

### FIELD OF THE INVENTION

The present invention relates to electronic assemblies. In particular, the present invention relates to surge protection assemblies and surge protection modules that comprise one or more surge protection varistors, methods of installing surge protection assemblies, and methods of installing surge protection modules.

### BACKGROUND

Surge protection devices (also known as “SPDs”, “surge protectors”, “surge arrestors”, “TVSS's”, “transient voltage surge suppressors” etc.) are widely used to guard electronic components against the damage that sudden power surges (caused by, e.g., lightning strikes or from large inductive loads, such as motors, being turned on and off) can cause. Surges are brief overvoltage spikes or disturbances on a power waveform that can damage, degrade, or destroy electronic equipment within any home, commercial building, industrial, or manufacturing facility. Transients can reach amplitudes of tens of thousands of volts.

In general, an SPD works by being installed in parallel with the electronic component(s) and/or other circuitry it is being employed to protect, and reducing resistance upon high voltage levels occurring (e.g., using a varistor), such that excess power is diverted away from the electronic component(s) and/or other circuitry being protected by the SPD. People of skill in the art are familiar with a wide variety of SPDs. SPDs can, for example, provide protection on any line-to-neutral mode, line-to-ground mode, line-to-line mode, or neutral-to-ground mode, or combinations of such modes.

### BRIEF SUMMARY OF THE INVENTION

This section (i.e., “Brief Summary of the Invention”) presents a simplified summary of the present inventive subject matter in order to provide a basic understanding of some aspects of the inventive subject matter. Included in this section are some concepts of the inventive subject matter as a prelude to more detailed descriptions of representative embodiments in accordance with aspects of the present inventive subject matter.

In some aspects, the present invention provides surge protection assemblies that can readily be installed by being attached to a junction box, and by connecting conductive elements of the surge protection assembly to circuitry conductive elements in the junction box (e.g., wires that extend into and/or pass through the junction box). For example, in some aspects of the present invention, a surge protection assembly in accordance with the present invention can be easily retrofit to an existing junction box. For example, in instances where one or more conduits (with wires inside) are attached to a junction box, a surge protection assembly in accordance with the present invention can be retrofit without the need to cut into one or more of the conduits to insert the surge protection assembly into the circuitry; instead, the surge protection assembly can be retrofit quickly and easily by attaching the surge protection assembly to the junction box (or by attaching the surge protection assembly to some other structure, e.g., a stud, near the junction box), and making wire connections (between the existing wires and wires from the surge protection assembly that pass through one or more holes created by removing one or more knockouts from the junction box) inside the junction box.

In some aspects of the present invention, as discussed herein, components of the surge protection assembly are arranged in a way that achieves a significant reduction in the overall volume of the surge protection assembly (in comparison, e.g., to conventional arrangements of SPDs), such that the overall size of the surge protection assembly is comparable to the overall size of a standard-size 2-gang junction box, whereby the surge protection assembly is capable of being installed at an advantageous location, in some instances where a conventional SPD arrangement would not fit.

SPDs have to be replaced occasionally. Factors that can cause SPDs to age, degrade, or reach their end-of-service condition over time (individually or in combination) include surges that exceed the SPDs' ratings for surge current, the rate of occurrence of surge events, the durations of surges, and sustained overvoltage events. Repetitive surge events of significant amplitude over a period of time can cause SPD components to overheat, causing the surge protective components to age. Repetitive surges can cause SPD disconnectors that are thermally activated to operate prematurely due to the heating of the surge protective components. In addition, characteristics of an SPD can change as it reaches its end-of-service condition (for example, measured limiting voltages can increase or decrease).

In accordance with some aspects of the present invention, there is provided a surge protection module that comprises two or more varistors, and that is movable as a unit and can be readily engaged with, and disengaged from, a surge protection assembly. In some aspects of the present invention, the arrangement of two or more varistors within a housing of the surge protection module is a major reason (or is the reason) that a significant reduction in the overall volume of the surge protection assembly can be achieved.

In some aspects of the present invention, a surge protection module in accordance with the present invention is field-replaceable in a surge protection assembly in accordance with the present invention, i.e., the surge protection module can be replaced without the need for any tools.

In accordance with a first aspect of the present invention, there is provided a surge protection assembly, comprising:
a surge protection assembly housing;
a surge protection assembly circuit board;
a surge protection module; and
at least first, second and third conductive elements of the surge protection assembly,
each of the first, second and third conductive elements of the surge protection assembly having a respective conductive element first region and a respective conductive element second region, each of the respective conductive element first regions is inside the surge protection assembly housing and is electrically connected to a respective conductive element contact region of the surge protection assembly circuit board, each of the respective conductive element second regions is outside the surge protection assembly housing,
the surge protection assembly circuit board comprises at least first, second and third terminal connection regions of the surge protection assembly circuit board,
the surge protection module comprising a surge protection module housing, at least first and second varistors, a surge protection module circuit board, and at least three surge protection module terminals, the first and second varistors are each inside the surge protection module housing, each of the surge protection module terminals comprising a respective terminal first region and a respective terminal second region, each of the terminal first regions is electrically connected to circuitry on the surge protection module circuit board, each of the terminal second regions is outside the surge protection module housing,
the surge protection module is movable as a unit, and is disengageable and re-engageable between an engaged arrangement and a disengaged arrangement,
in the engaged arrangement, each of the terminal second regions is electrically connected to a respective one of the terminal connection regions of the surge protection assembly circuit board, and
in the disengaged arrangement, each of the terminal second regions is electrically disconnected from each of the terminal connection regions of the surge protection assembly circuit board.

In some embodiments in accordance with the first aspect of the present invention, the surge protection module terminals extend through openings in the surge protection module housing. In some of such embodiments, all of the openings are on a first side of the surge protection module housing.

In some embodiments in accordance with the first aspect of the present invention, the surge protection module circuit board is inside the surge protection module housing.

In some embodiments in accordance with the first aspect of the present invention, wherein at least one of the at least first and second varistors is a metal oxide varistor.

In some embodiments in accordance with the first aspect of the present invention, the surge protection module further comprises a third varistor that is inside the surge protection module housing.

In some embodiments in accordance with the first aspect of the present invention:
the surge protection assembly further comprises an assembly housing insert,
the assembly housing insert is inside the surge protection assembly housing, and
the assembly housing insert comprises a surge protection module-accommodating recess that geometrically interfaces with the surge protection module.

In some embodiments in accordance with the first aspect of the present invention:
the surge protection assembly further comprises a conductive elements support,
the conductive elements support holds the at least first, second and third conductive elements of the surge protection assembly in place relative to the conductive elements support, and
the surge protection assembly housing and the conductive elements support are configured to hold the conductive elements support in place relative to the surge protection assembly housing. In some of such embodiments, the conductive elements extend through the conductive elements support.

In some embodiments in accordance with the first aspect of the present invention, the surge protection assembly housing comprises an external pipe thread.

In some embodiments in accordance with the first aspect of the present invention, the surge protection module housing comprises a cover and a base.

In some embodiments in accordance with the first aspect of the present invention, the surge protection module comprises a pull handle pivotally attached to the surge protection module housing.

In accordance with a second aspect of the present invention, there is provided a surge protection module, comprising:
a surge protection module housing;
at least first and second varistors;
a surge protection module circuit board; and
at least three surge protection module terminals,
the first and second varistors are in an internal surge protection module space defined by the surge protection module housing,
each of the surge protection module terminals comprising a respective terminal first region and a respective terminal second region, each of the terminal first regions is electrically connected to circuitry on the surge protection module circuit board, each of the terminal second regions is outside the surge protection module housing, and
the surge protection module is movable as a unit.

In some embodiments in accordance with the second aspect of the present invention, the surge protection module is capable of being engaged with a surge protection assembly that has openings to receive at least respective portions of the surge protection module terminals and contacts to make electrical contact with the respective surge protection module terminals.

In some embodiments in accordance with the second aspect of the present invention, the surge protection module terminals extend through openings in the surge protection module housing. In some of such embodiments, all of the openings are on a first side of the surge protection module housing.

In some embodiments in accordance with the second aspect of the present invention, the surge protection module circuit board is inside the surge protection module housing.

In some embodiments in accordance with the second aspect of the present invention, at least one of the at least first and second varistors is a metal oxide varistor.

In some embodiments in accordance with the second aspect of the present invention, the surge protection module further comprises a third varistor that is inside the surge protection module housing.

In some embodiments in accordance with the second aspect of the present invention, the surge protection module housing comprises a cover and a base.

In some embodiments in accordance with the second aspect of the present invention, the surge protection module comprises a pull handle pivotally attached to the surge protection module housing.

In some embodiments in accordance with the second aspect of the present invention, the surge protection module housing comprises a cover and a base.

In some embodiments in accordance with the second aspect of the present invention, the surge protection module comprises a pull handle pivotally attached to the surge protection module housing.

In accordance with a third aspect of the present invention, there is provided an electronic assembly with a surge protection assembly, comprising:
a junction box;
a plurality of circuitry conductive elements; and
a surge protection assembly,
the surge protection assembly comprising a surge protection assembly housing, a surge protection assembly circuit board, a surge protection module, and at least first, second and third conductive elements of the surge protection assembly,
each of the first, second and third conductive elements of the surge protection assembly having a respective conductive element first region and a respective conductive element second region, each of the respective conductive element first regions is inside the surge protection assembly housing and is electrically connected to a respective conductive element contact region of the surge protection assembly circuit board, each of the respective conductive element second regions is outside the surge protection assembly housing,
the surge protection assembly circuit board comprises at least first, second and third terminal connection regions of the surge protection assembly circuit board,
the surge protection module comprising a surge protection module housing, at least first and second varistors, a surge protection module circuit board, and at least three surge protection module terminals, the first and second varistors are each inside the surge protection, module housing, each of the surge protection module terminals comprising a respective terminal first region and a respective terminal second region, each of the terminal first regions is electrically connected to circuitry on the surge protection module circuit board, each of the terminal second regions is outside the surge protection module housing,
the surge protection module is movable as a unit, and is disengageable and re-engageable between an engaged arrangement and a disengaged arrangement,
in the engaged arrangement, each of the terminal second regions is electrically connected to a respective one of the terminal connection regions of the surge protection assembly circuit board,
in the disengaged arrangement, each of the terminal second regions is electrically disconnected from each of the terminal connection regions of the surge protection assembly circuit board, and
each of the conductive elements of the surge protection assembly is electrically connected to one of the circuitry conductive elements.

In some embodiments in accordance with the third aspect of the present invention;
the electronic assembly with a surge protection assembly further comprises a pipe thread nut,
the junction box comprises a knockout opening,
the surge protection assembly housing further comprises an external pipe thread,
the external pipe thread of the surge protection assembly housing extends through the knockout opening of the junction box, and
the pipe thread nut is in the junction box and threaded on the external pipe thread of the surge protection assembly housing.

In some embodiments in accordance with the third aspect of the present invention, the surge protection module terminals extend through openings in the surge protection module housing. In some of such embodiments, all of the openings are on a first side of the surge protection module housing.

In some embodiments in accordance with the third aspect of the present invention, the surge protection module circuit board is inside the surge protection module housing.

In some embodiments in accordance with the third aspect of the present invention, at least one of the at least first and second varistors is a metal oxide varistor.

In some embodiments in accordance with the third aspect of the present invention, the surge protection module further comprises a third varistor that is inside the surge protection module housing.

In some embodiments in accordance with the third aspect of the present invention:
the surge protection assembly further comprises an assembly housing insert,
the assembly housing insert is inside the surge protection assembly housing, and
the assembly housing insert comprises a surge protection module-accommodating recess that geometrically interfaces with the surge protection module.

In some embodiments in accordance with the third aspect of the present invention:
the surge protection assembly further comprises a conductive elements support,
the conductive elements support holds the at least first, second and third conductive elements of the surge protection assembly in place relative to the conductive elements support, and
the surge protection assembly housing and the conductive elements support are configured to hold the conductive elements support in place relative to the surge protection assembly housing. In some of such embodiments, the conductive elements extend through the conductive elements support.

In some embodiments in accordance with the third aspect of the present invention, the surge protection module housing comprises a cover and a base.

In some embodiments in accordance with the third aspect of the present invention, the surge protection module comprises a pull handle pivotally attached to the surge protection module housing.

In accordance with a fourth aspect of the present invention, there is provided a method of installing a surge protection assembly to a plurality of circuitry conductive elements, the method comprising:
electrically connecting a plurality of conductive elements of a surge protection assembly to respective circuitry conductive elements in a junction box,
the surge protection assembly comprises a surge protection assembly housing, a surge protection assembly circuit board, a surge protection module, and at least first, second and third conductive elements of the surge protection assembly,
each of the first, second and third conductive elements of the surge protection assembly having a respective conductive element first region and a respective conductive element second region, each of the respective conductive element first regions is inside the surge protection assembly housing and is electrically connected to a respective conductive element contact region of the surge protection assembly circuit board, each of the respective conductive element second regions is outside the surge protection assembly housing,
the surge protection assembly circuit board comprises at least first, second and third terminal connection regions of the surge protection assembly circuit board,
the surge protection module comprising a surge protection module housing, at least first and second varistors, a surge protection module circuit board, and at least three surge protection module terminals, the first and second varistors are each inside the surge protection module housing, each of the surge protection module terminals comprising a respective terminal first region and a respective terminal second region, each of the terminal first regions is electrically connected to circuitry on the surge protection module circuit board, each of the terminal second regions is outside the surge protection module housing,
the surge protection module is movable as a unit, and is disengageable and re-engageable between an engaged arrangement and a disengaged arrangement,
in the engaged arrangement, each of the terminal second regions is electrically connected to a respective one of the terminal connection regions of the surge protection assembly circuit board, and
in the disengaged arrangement, each of the terminal second regions is electrically disconnected from each of the terminal connection regions of the surge protection assembly circuit board.

In some embodiments in accordance with the fourth aspect of the present invention, the surge protection module terminals extend through openings in the surge protection module housing. In some of such embodiments, all of the openings are on a first side of the surge protection module housing.

In some embodiments in accordance with the fourth aspect of the present invention, the surge protection module circuit board is inside the surge protection module housing.

In some embodiments in accordance with the fourth aspect of the present invention:
the surge protection assembly housing comprises an external pipe thread, and
the method further comprises threading a pipe thread nut on the external pipe thread of the surge protection assembly housing.

The inventive subject matter may be more fully understood with reference to the accompanying drawings and the following detailed description of the inventive subject matter.

### BRIEF DESCRIPTION OF THE DRAWING FIGURES

FIG. 1 is a first schematic perspective view of a surge protection device 10.

FIG. 2 is a cross-sectional view taken along the plane II-II in FIG. 1.

FIG. 3 is a schematic plan view of the side of the surge protection assembly circuit board 12 closer to the assembly housing insert 26 (i.e., facing to the left in the orientation depicted in FIG. 2).

FIG. 4 is a second schematic perspective view of the surge protection device 10. FIG. 4 is similar to FIG. 1, except that in FIG. 4, the surge protection module 13 has been removed from a surge protection module-accommodating recess 27 in the assembly housing insert 26.

FIG. 5 is a schematic exploded perspective view of the surge protection module 13.

FIG. 6 is a schematic perspective (non-exploded) view of the surge protection module 13 shown in FIG. 5.

FIG. 7 schematically depicts an arrangement in which the surge protection assembly 10 is ready to be securely mounted to a junction box 33 by inserting an external pipe thread 32 through a knockout opening 34 in the junction box 33, and then threading a pipe thread nut 35 onto the external pipe thread 32, prior to connecting the conductive elements 14 to appropriate wires (not shown) in the junction box 33.

FIG. 8 is a schematic top view (i.e., a view in a direction 36 depicted in FIG. 4) of an interior of a right part of the surge protection assembly 10 depicted in FIGS. 1, 4 and 7 (i.e., a part of the surge protection assembly 10 closer to the external pipe thread 32), with the surge protection module 13, the assembly housing insert 26 and the surge protection assembly circuit board 12 removed so that a right part of the surge protection assembly housing 11 and portions of the conductive elements 14 are visible.

FIG. 9 is a schematic perspective view that is similar to FIG. 8 (except that FIG. 9 is a perspective view, whereas FIG. 8 is a top view).

FIG. 10 schematically depicts a sequence in which a surge protection module is disengaged from a surge protection module-accommodating recess of a surge protection assembly.

### DETAILED DESCRIPTION OF THE INVENTION

Unless otherwise defined, all terms (including technical and scientific terms) used herein have the same meaning as commonly understood by one of ordinary skill in the art to which this inventive subject matter belongs. Terms and expressions, such as those defined in commonly used dictionaries, should each be interpreted as having a meaning that is consistent with their meaning in the context of the relevant art and the present disclosure, and not in an idealized or overly formal sense (unless expressly so defined herein).

The expression “invention” is used herein to refer to any portion (or portions) of the inventive subject matter disclosed herein. As described herein, the present invention includes many aspects.

Where an expression is defined herein in terms of the meaning of the expression in the singular, the definition applies also to the plural (and vice-versa, i.e., for an expression defined herein in the plural, the definition applies also to the singular), Definitions of one form of an expression apply to the same expression in a different form of the word or words.

As used herein, the singular forms “a”, “an” and “the” are intended to include the plural forms as well, unless the context clearly indicates otherwise.

Although the terms “first”, “second”, etc. are in some instances used herein to describe various components, such terms do not indicate any sequence or relative importance, and such components are not limited by these terms. These terms are only used to label components. Thus, a first component (e.g., a first conductive element of a surge protection assembly) discussed herein could be termed a second component, a third component, etc. without departing from the teachings of the present inventive subject matter.

The expression “comprises” or “comprising,” as used herein, is used in accordance with its well known usage, and means that the item that “comprises” the recited elements (or that is “comprising” the recited elements) includes at least the recited elements, and can optionally include any additional elements. For example, a surge protection assembly “comprising” a surge protection assembly housing; at least a first surge protection assembly circuit board; a surge protection module; and at least first, second and third conductive elements of the surge protection assembly, comprises at least one surge protection assembly housing, at least one surge protection assembly circuit board, at least one surge protection module, and at least three conductive elements, and can include more of any of the recited components (e.g., two surge protection modules) and/or it can include other components (i.e., not recited), e.g., one or more external pipe threads, one or more pipe thread nuts, one or more assembly housing inserts, a fourth conductive element (and/or more conductive elements), one or more wires, etc.

Relative terms, such as “bottom”, “below”, “top”, “horizontal” or “vertical” may be used herein to describe one element's relationship to another element (or to other elements), e.g., as illustrated in the Figures. Such relative terms are intended to encompass different orientations of the device in addition to the orientation depicted in the Figures and/or as described herein. For example, if a device is turned over, elements described as being on the “top” side of other elements would then be oriented on “bottom” sides of the other elements. The exemplary term “top” can therefore encompass both an orientation of “top” and “bottom.” depending on the particular orientation. Similarly, if a device is turned over, elements described as “below” other elements would then be oriented “above” the other elements.

The expression “in some embodiments,” as used herein, refers to features that can be included in some embodiments and not others, i.e., the feature(s) is/are optional. Where the expression “in some embodiments” is used, the embodiment can include the feature discussed, and can also include or not include any of other features described herein, including features that are similarly described as being provided “in some embodiments.”

A statement herein that an element is “on” another element (e.g., “a contact on a circuit board”), means that the element can be in or on the other element, and/or it can be in direct contact or indirect contact with the other element (e.g., intervening elements may also be present).

The term “contact” (or “contact region”) is used herein to refer to any structure through which electrical connection can be established, i.e., any electrically conductive region on a component. For example, where a terminal (e.g., a spring-loaded metallic terminal) of a surge protection module is in direct physical contact with a contact (e.g., a substantially flat metallic region) on a surge protection assembly circuit board, electricity can be conducted between the terminal and the contact, (e.g., the terminal of the surge protection module and the contact on the surge protection assembly circuit board are directly electrically connected, and are in direct electrical contact).

The expression “engageable” (and related expressions, e.g., “engaged”, “disengageable”, “re-engageable”), e.g., in the expression “the surge protection module is movable as a unit, and is disengageable and re-engageable between an engaged arrangement and a disengaged arrangement,” (also, “capable of being engaged”) means that the item (a first item) that is “engageable” with another item (a second item) can be engaged with the second item by applying force by hand by a normal human, and, when engaged, is held in place relative to the second item, and the first item can also be disengaged (i.e., removed) from the second item by applying force by hand by a normal human (e.g., by pulling the first item out of engagement with the second item).

Recitation herein that a surge protection module is “field-replaceable” (e.g., in the expression “a surge protection module in accordance with the present invention is field-replaceable in a surge protection assembly in accordance with the present invention”) means that the item is “removably engageable”, i.e., it is engageable with and disengageable from the surge protection assembly by a normal person without the use of tools, e.g., using force of 100 N or less, and once it is removably engaged with the surge protection assembly, it can be removed from the surge protection assembly by a normal person without the use of tools, e.g., using force of 100 N or less.

The expression “movable as a unit,” as used herein (e.g., in the expression “the surge protection module is movable as a unit”), means that (unless the item is broken) by moving any portion of the item that is movable as a unit, all other portions of the item move (with the exception of a point of rotation or an axis of rotation, if the movement is solely rotational about a point or an axis), i.e., the location of each portion of the item relative to every other portion of the item does not change upon any portion of the item being moved, and/or upon the item being rotated.

The expression “geometrically interfaces with” (e.g., in the expression “the assembly housing insert comprises a surge protection module-accommodating recess that geometrically interfaces with the surge protection module”), as used herein, means that at least a portion of the surge protection module fits snugly within the surge protection module-accommodating recess, i.e., portions of the surge protection module occupy at least 90 percent (and in some cases, at least 95 percent, 97 percent, or 98 percent), of the space defined by the surge protection module-accommodating recess.

The expression “space defined by” (e.g., in the expression “portions of the surge protection module occupy at least 90 percent of the space defined by the surge protection module-accommodating recess” and in the expression “the first and second varistors are in an internal surge protection module space defined by the surge protection module housing”) means that the item or items that “define the space” completely surround the internal space, or that the item or items that “define the internal space” plus one or more imaginary planes (each imaginary plane defined by at least three points on the item or items) completely surround the internal space. For example, a five-sided rectilinear box (with an open top side) defines an internal space that would be completely surrounded by the box if a sixth side (top side) of the box were added that is contiguous with the tops of the sides of the five-sided box. Similarly, a shape with a bottom horizontal hexagonal side and six sidewalls of equal size, each extending upright from one of the six sides, with each sidewall having a circular opening, defines an internal space. Likewise, a generally prismatic shape of rectangular or square cross-section, with gaps, cracks and openings (e.g., through which wires extend from outside the shape to inside the shape), defines an internal space. Another way an internal space can be “defined” is in terms of the largest volume of liquid that could be retained by the structure that “defines” a space in any orientation, with openings, gaps or cracks (such as the terminal connection regions) sealed. Accordingly, once a surge protection module is engaged with a surge protection module-accommodating recess in accordance with the present invention, the surge protection module is held in place relative to the surge protection module-accommodating recess to an extent that reliable electrical contact is maintained between the surge protection module terminals of the surge protection module and the respective corresponding terminal connection regions of the surge protection assembly circuit board.

A statement herein that two (or more) components in a device are “electrically connected,” means that the items that are described as being electrically connected to each other are directly electrically connected to each other (as defined herein), or are both in a sequence of items that are directly electrically connected to each other, e.g., two components can be electrically connected to each other via one or more intervening items that are each directly connected to other items in the sequence. For example, where a first electrically conductive item is directly electrically connected to a second (intervening) electrically conductive item (at a first location of the second electrically conductive item), and the second electrically conductive item is (at a second location of the second electrically conductive item) directly electrically connected to a third electrically conductive item, the first electrically conductive item and the third electrically conductive item are “electrically connected” to each other (and they are “in electrical connection” with each other), even though they are not in direct electrical connection with each other. Thus, two components can be referred to as being electrically connected, even though they may have a small resistor between them which does not materially affect the function or functions provided by the device (indeed, a wire connecting two components can be thought of as a small resistor); likewise, two (or more) components can be referred to as being electrically connected, even though they may have an additional electrical component between them that allows the device to perform an additional function, while not materially affecting the function or functions provided by a device that is identical except for not including the additional component; similarly, two components that are directly connected to each other, or which are directly connected to opposite ends of a wire or a trace on a circuit board, are electrically connected.

A statement herein that two (or more) components in a device are “directly electrically connected,” means that electrically conductive regions of the two (or more) components are in direct contact with each other (or that the two or more components are electrically conductive and are in direct contact with each other)

A statement herein that two (or more) components in a device are “electrically disconnected,” means that the items that are described as being electrically disconnected to each other are not directly electrically connected to each other, nor are they both in a sequence of items that are directly electrically connected to each other.

The expression “electrical contact,” as used herein means that the items that are in “electrical contact” are in physical contact, or in close enough proximity, that electricity can be conducted from one of the items to the other (or others), i.e., such that they are electrically connected. For example, two electrically conductive structures that are in physical contact (such that electricity can flow from one to the other) are in electrical contact.

The term “plurality,” as used herein, means two or more, i.e., it encompasses two, three, four, five, etc. For example, the expression “plurality of circuitry conductive elements” encompasses two circuitry conductive elements, three circuitry conductive elements, four circuitry conductive elements, etc.

The expression “electrically in parallel” is used herein in relation to electronic components in accordance with its well known meaning, to refer to arrangements in which one or more of the components are in each of at least two separate paths, and current can potentially flow through either or both each of the separate paths, whereas the expression “electrically in series” is used herein in relation to electronic components in accordance with its well known meaning, to refer to arrangements in which current flows sequentially through the components in a single path.

As noted above, the present invention provides surge protection assemblies that each comprise a surge protection assembly housing. The surge protection assembly housing can be constructed from any suitable material or materials (e.g., metal or plastic), can be of any suitable shape and size, and can be constructed of any suitable number of pieces. In some embodiments, the surge protection assembly housing comprises at least first and second parts that can be attached together to provide an interior space in which at least the surge protection module, the surge protection assembly circuit board, portions of the conductive elements, and the assembly housing insert are positioned. In some embodiments, the surge protection assembly housing comprises at least two parts, one of which is in the form of a removable cover or a cover that comprises a door, e.g., a hinged door that comprises a latch that holds the door closed until a user desires to open the door (e.g., by manipulating the latch to free the door to be opened) to gain access to the surge protection module or anything else inside the surge protection assembly housing.

As noted above, the surge protection assembly housings in accordance with the present invention can be of any suitable size and shape (e.g., of substantially square or rectangular cross-section, such as: 4-5 inches wide×5-6 inches tall×1.5-3.5 inches deep (e.g., 2 inches deep), 2 inches×4 inches×1.5-3.5 inches deep (e.g., 2 inches deep), 8 inches×10 inches×5 inches deep, circular cross-section, such as 3-5 (e.g., 4) inches diameter×1.5-3.5 inches deep (e.g., 2.3 inches deep), octagonal cross-section, or irregular shapes of any dimensions, and that are made of any suitable material or combination of materials, e.g., metal (such as aluminum, steel (e.g., stainless steel), cast iron, etc.) plastic (such as polycarbonate, ABS or PVC), or fiberglass. For example, surge protection assembly housings in accordance with the present invention can be of size and shape equal to or roughly equal to a standard-size 2-gang electrical box (e.g., 4 inches×4 inches×1.5-3.5 inches deep, such as 4 inches×4 inches×2 inches deep).

As noted above, the present invention provides surge protection assemblies that each comprise a surge protection assembly circuit board. Those of skill in the art are familiar with a wide variety of circuit boards, and any suitable circuit board can be employed as a surge protection assembly circuit board. In some embodiments, the surge protection assembly circuit board(s) can be metal core circuit boards (which provide relatively high heat conductivity) or FR4 circuit boards.

As also noted above, the present invention provides surge protection modules, and surge protection assemblies that each comprise a surge protection module, in which each surge protection module comprises a surge protection module circuit board. Any suitable circuit board can be employed as a surge protection module circuit board. In some embodiments, the surge protection module circuit board(s) can be metal core circuit boards (which provide relatively high heat conductivity) or FR4 circuit boards.

Circuitry that provides surge protection is provided on a surge protection module circuit board, or on a surge protection assembly circuit board, or in any combination on the two (or more) circuit boards (i.e., the circuitry for providing surge protection can be allocated in any suitable way between the circuit boards). Those of skill in the art are familiar with a wide variety of arrangements of electronic components to provide surge protection (e.g., in any suitable circuitry such that the varistors function as variable resistance resistors electrically in parallel with the component(s) and/or circuitry that is being protected), and any of such arrangements are encompassed by the present invention.

As noted above, some embodiments of surge protection assemblies in accordance with the present invention comprise an assembly housing insert. A surge protection assembly housing insert can be constructed from any suitable material or materials (e.g., insulating plastic), can be of any suitable shape and size, and can be constructed of any suitable number of pieces. Statements herein that an assembly housing insert (and/or a surge protection module-accommodating recess of an assembly housing insert) “accommodates” a surge protection module does not require that the surge protection module must fit completely within the surge protection module-accommodating recess (or the assembly housing insert), and it instead means that at least a portion of the surge protection module fits in the surge protection module-accommodating recess, and, as discussed elsewhere herein, geometrically interfaces with the surge protection module-accommodating recess.

As noted above, the present invention provides surge protection assemblies that each comprise conductive elements. The expression “conductive element,” as used herein, means any structure that is configured to carry electrical current (e.g., a wire, a wire bond, a trace, a thin metallic structure that has a large surface area, such as a plate (which can be planar or curved), etc.). In some embodiments, the conductive elements are insulated wires.

As noted above, the present invention provides surge protection modules, and surge protection assemblies that each comprise a surge protection module, in which each surge protection module comprises a surge protection module housing. The surge protection module housing can be constructed from any suitable material or materials (e.g., insulating plastic), can be of any suitable shape and size, and can be constructed of any suitable number of pieces. In some embodiments, the surge protection module housing comprises a first part and a second part. In some embodiments, the surge protection module housing comprises first and second parts in the form of a base and a cover, and the cover is attached to the base after positioning components (e.g., a surge protection module circuit board, surge protection module terminals and varistors) in the base.

As noted above, the present invention provides surge protection modules, and surge protection assemblies that each comprise a surge protection module, in which each surge protection module comprises two or more varistors. Those of skill in the art are familiar with a wide variety of varistors, and any of such varistors can be used in surge protection assemblies and surge protection modules as described herein. That is, the present invention is not limited to any type of varistor. In some aspects of the present invention, one or more of the varistors each comprises a metal oxide varistor or a silicon carbide varistor; in some aspects of the present invention, all of the varistors are metal oxide varistors.

As noted above, the present invention provides surge protection modules, and surge protection assemblies that each comprise a surge protection module, in which each surge protection module comprises a plurality of surge protection module terminals that are configured to engage and disengage with respective terminal connection regions of a surge protection assembly circuit board. In some embodiments, the surge protection module terminals can be retracted out of the terminal connection regions (e.g., in the form of recesses) by moving the surge protection module from an engaged arrangement to a disengaged arrangement. In some embodiments, the respective shapes of the terminal connection regions and the surge protection module terminals are such that excessive force is not required to move the surge protection module from a disengaged arrangement to an engaged arrangement, or from an engaged arrangement to a disengaged arrangement, i.e., so that (as noted elsewhere) the surge protection module is field-replaceable. The surge protection module terminals and the terminal connection regions can be of any suitable shapes and sizes, and can be configured in any suitable way such that electrical contact between the surge protection module terminals and the respective terminal connection regions is ensured. In some embodiments, each surge protection module terminal is generally U-shaped, whereby a free side of the U-shape is spring-loaded, and from its rest position can be flexed toward the side of the U-shape that is connected to the surge protection module circuit board (such flexing resulting in the free side being biased toward its rest position), so that upon being inserted into a recess of a terminal connection region, the free side is flexed toward the side of the U-shape that is connected to the surge protection module circuit board, whereby in an engaged arrangement, the surge protection module terminal exerts force against opposite sides of the recess, such force serving to hold the surge protection module terminal in place relative to the recess, and ensuring secure electrical contact between the surge protection module terminal and the terminal connection region.

The surge protection module terminals and the corresponding terminal connection regions can be provided in any suitable locations, and the portions of the terminal connection regions where the surge protection module terminals come into electrical contact can be at any location, e.g., on the sides of recesses into which the surge protection module terminals are inserted, at the bottoms of such recesses, or below an open-bottomed recess (i.e., below the openings).

In another aspect of the present invention, there are provided plural surge protection modules that comprise different quantities of varistors, and respective assembly housing inserts that have respective surge protection module-accommodating recesses of different sizes that accommodate (and geometrically interface with) the different surge protection modules, and the respective different assembly housing inserts fit into the same surge protection assembly housing (i.e., the same surge protection assembly housings can be used to make surge protection assemblies that have different numbers of varistors). For example, a smaller surge protection module can be provided to accommodate the varistors where only two varistors are needed, or a larger surge protection module can be provided to accommodate a number of varistors that is three or greater than three), and the smaller surge protection modules can be accommodated in assembly housing inserts that have smaller surge protection module-accommodating recesses while the larger surge protection modules can be accommodated in assembly housing inserts that have larger surge protection module-accommodating recesses, and either of the kinds of assembly housing inserts (i.e., those that have smaller surge protection module-accommodating recesses and those that have larger surge protection module-accommodating recesses) can be accommodated in the same surge protection assembly housing.

In some embodiments, surge protection modules and surge protection module-accommodating recesses can be keyed to one another, e.g., each surge protection module can have protrusions (and/or ridges) and/or grooves that align with corresponding grooves and/or protrusions (and/or ridges) in or on only surge protection module-accommodating recesses that are a proper match for the surge protection module. That is, the protrusions (and/or ridges) and/or grooves allow a surge protection module to be inserted into a surge protection module-accommodating recess only if the surge protection module is properly matched to the surge protection assembly circuit board in the surge protection assembly housing in which the assembly housing insert (which has the surge protection module-accommodating recess) is positioned; if an attempt is made to insert an incorrectly matched surge protection module into an assembly housing insert, or if an attempt is made to insert a correctly matched surge protection module into an assembly housing insert in an incorrect orientation, the surge protection module will not fit into the assembly housing insert.

As noted above, some embodiments of surge protection modules in accordance with the present invention comprise a pull handle. A pull handle, if provided, can be of any suitable size and shape, and can be made of any suitable material, e.g., plastic or metal. In some embodiments, a pull handle is pivotally attached to the surge protection module housing, e.g., to a cover that is attached to a base to form a surge protection module housing. In some embodiments, a pull handle is pivotally attached to the surge protection module housing by portions of the pull handle extending into spaces defined by pull handle retaining structures (which can be integral with the surge protection module housing), e.g., the pull handle retaining structures and the surge protection module housing can both be part of a one-piece unitary structure, or the pull handle retaining structures can be attached to the surge protection module housing.

With the surge protection module fully pressed into a surge protection module-accommodating recess of a surge protection assembly (i.e., in an engaged arrangement), each of the surge protection module terminals is in electrical contact with a respective terminal connection region of the surge protection assembly circuit board. In some embodiments, by pulling on the pull handle (without using any tools), a normal person can remove the surge protection module from the surge protection module-accommodating recess (and from the remainder of the surge protection assembly) (i.e., the surge protection module is field-replaceable), whereby each of the surge protection module terminals becomes electrically disconnected from the respective terminal connection region.

In some embodiments of surge protection assemblies according to the present invention, the surge protection assembly housing further comprises an external pipe thread that is integral with the surge protection assembly housing (in some of such embodiments, the external pipe thread and the surge protection assembly housing are both part of a one-piece integral structure), With such embodiments, the surge protection assembly can be securely mounted to a junction box by inserting the external pipe thread through a knockout opening in the junction box, and then threading a pipe thread nut onto the external pipe thread, prior to connecting the conductive elements of the surge protection assembly to appropriate conductive elements (e.g., wires) in the junction box (e.g., in an existing circuit). Using such an installation procedure, the surge protection assembly can be easily and quickly mounted alongside a junction box (e.g., a standard-size 2-gang electrical box) without the need to cut into any conduits in an existing electrical arrangement, etc., to provide surge protection, e.g., for a load connected to wires in the 2-gang electrical box.

As noted above, some embodiments of surge protection assemblies in accordance with the present invention further comprise a conductive elements support that holds the conductive elements of the surge protection assembly (i.e., wires or other conductive elements that extend from outside the surge protection assembly housing to inside the surge protection assembly housing and that are each electrically connected to a respective conductive element contact region of the surge protection assembly circuit board). A conductive elements support (in embodiments that comprise one) can be made of any suitable material or materials, and can be of any suitable shape and size, and it can be configured to hold the conductive elements in place and mitigate strain, e.g., so that if one or more of the conductive elements is pulled (e.g., a force is exerted on one of more of the conductive elements, tending to pull the conductive element(s) away from the surge protection assembly circuit board), the conductive elements support holds the conductive element(s) in place, such that the force does not move the conductive elements relative to the conductive elements support or pull the conductive elements partially or fully out of the conductive elements support, and such that force is not exerted on the surge protection assembly circuit board (nor is the force transmitted to portions of the conductive elements that are connected to the surge protection assembly circuit board). In some of such embodiments, each of the conductive elements extends through the conductive elements support (e.g., by forming the conductive elements support around the conductive elements, the conductive elements extend through the conductive elements support; alternatively, the conductive elements support could be formed from two or more pieces that include grooves to accommodate the conductive elements and are connected so as to press on the conductive elements, or the conductive elements could be forced through openings in which the conductive elements tightly fit (in some cases, one conductive element per opening, in other cases two or more conductive elements can be held in some or all of the openings)), such that the conductive elements are held in place. In some of such embodiments, the conductive elements support can be resilient to some degree.

In some embodiments that comprises a conductive elements support, there can further be provided structure that cooperates with the conductive elements support to hold the conductive elements support in place. For example, in some embodiments of surge protection assemblies in accordance with the present invention, the surge protection assembly housing has ribs, and the conductive elements support has notches that receive the ribs of the surge protection assembly housing, such that the conductive elements support is held in place relative to the surge protection assembly housing.

In some embodiments of surge protection assemblies or surge protection modules in accordance with the present invention, the surge protection assembly or surge protection module can comprise one or more surge protection status indicators, which can be located in any suitable position or positions, e.g., on one or more circuit boards of the surge protection assembly or surge protection module (such as on a surge protection assembly circuit board or on a surge protection module circuit board). A surge protection status indicator (where provided) can indicate: that the surge protection module (i.e., at least one varistor) is in need of replacement, that the surge protection module is in good working condition, that the surge protection module's protection capacity has become exhausted, the number of times electricity has been diverted to the surge protection module or one or more of the varistors in the surge protection module (i.e., the number of “hits” the surge protection module and/or one or more of the varistors has taken), the cumulative amount of energy that has been diverted to the surge protection module or one or more of the varistors in the surge protection module, the relative degree to which the protection capacity of the surge protection module or one or more of the varistors in the surge protection module has been depleted, etc. The surge protection status indicator can comprise or consist of any of a visual indication (e.g., one or more light emitters, such as LEDs), an audible indication, or an electrical signal (transmitted entirely through wires, transmitted through wires and wirelessly, or transmitted entirely wirelessly). Wireless transmission of a signal, where employed, can be by any suitable type of wireless signal, e.g., microwave signals, RE signals (cellular, bluetooth, BLE, LTE, RFID, NFC, etc.), IR signals, etc.; any wireless transmitter(s) and/or wireless receivers(s) (and/or wireless transceivers) can be provided in any suitable locations, e.g., on a circuit board as described herein. A visual signal can be a single light emitter (e.g., a light emitter that emits light when the surge protection module or one or more of the varistors in the surge protection module is in good condition and does not emit light when the surge protection module or one or more of the varistors in the surge protection module is exhausted or is nearing the point where it needs to be replaced (or vice-versa)), or plural light emitters (e.g., different quantities of light emitters are illuminated to indicate the condition of the surge protection module or one or more of the varistors in the surge protection module, and/or different colored light emission indicates the condition of the surge protection module or one or more of the varistors in the surge protection module, etc.). In some embodiments, one or more light pipes (comprising optical fibers) and/or light guides can be provided to convey light emitted by one or more light emitters to another location (e.g., where the light emitter is positioned at a location that is difficult or impossible to see from outside the surge protection assembly housing). An audible signal can be emitted (continuously or intermittently) upon the surge protection module or one or more of the varistors in the surge protection module becoming exhausted or nearing the point where it needs to be replaced. An audible signal can be generated where a detector (e.g., that senses a surge protector status characteristic) resides, or remote from where the detector resides (e.g., by transmission and receipt of a wireless signal, and/or by passing a signal through wire).

As noted above, the surge protection assemblies and surge protection modules can be used to provide surge protection to circuitry, components or loads that comprise a junction box or that are supplied energy through circuitry that comprises a junction box. Those of skill in the art are familiar with a wide variety of junction boxes, and any such junction box can be used in electronic assemblies as described herein. The surge protection assemblies and surge protection modules in accordance with the present invention can be used with junction boxes of any suitable size and shape (e.g., of substantially square or rectangular cross-section, such as: 4-5 inches wide×5-6 inches tall×1.5-3.5 inches deep (e.g., 2 inches deep), 2 inches×4 inches×1.5-3.5 inches deep (e.g., 2 inches deep), 8 inches×10 inches×5 inches deep, circular cross-section, such as 3-5 (e.g., 4) inches diameter×1.5-3.5 inches deep (e.g., 2.3 inches deep), octagonal cross-section, or irregular shapes of any dimensions, and that are made of any suitable material or combination of materials, e.g., metal (such as aluminum, steel (e.g., stainless steel), cast iron, etc.) plastic (such as polycarbonate, ABS or PVC), or fiberglass. For example, surge protection assemblies and surge protection modules in accordance with the present invention can be used with junction boxes that are a standard-size 2-gang electrical box (e.g., 4 inches×4 inches×1.5-3.5 inches deep, such as 4 inches×4 inches×2 inches deep).

The surge protection assemblies and surge protection modules in accordance with the present invention can be used with junction boxes that are of any rating, e.g., any rating between 1 and 13, such as NEMA 1, NEMA 3, NEMA 3R, NEMA 3RX, NEMA4, NEMA 4X, NEMA 12, i.e., they can satisfy standards for resistance to any environmental hazard or combinations of environmental hazards, e.g., depending on the use to which the surge protection assembly is being configured to be applied.

People of skill in the art are familiar with a variety of junction box knockouts (and knockout openings created by removing one or more knockouts), and any such junction box knockouts (and/or knockout opening) can be provided in junction boxes as described herein. The expression “junction box knockouts” is used herein to refer to a portion of a junction box that can readily be separated from the rest of the junction box (e.g., by pressing with a screwdriver to partially dislodge it and then twisting it by hand to completely remove it), e.g., a pre-scored circular region of a diameter of 3/2 inch, ¾ inch, 1.5 inches or 2 inches.

The surge protection assemblies and surge protection modules in accordance with the present invention can be of any rating, e.g., 20 kA, 10 KA, 5 kA or 3 kA, and can be of any type (e.g., Type I, Type II or Type III), and can be installed in any suitable locations, electrically in series and/or electrically in parallel with any component(s) or circuit(s) (e.g., before a service panel, before or after a circuit breaker, before or after an electronic component or circuit, in parallel with an electronic component or circuit, etc.), with single phase power or three phase power, connected line-to-line, line-to-neutral, line-to-ground, neutral-to-neutral, neutral-to-ground, or ground-to-ground.

In some embodiments of electronic assemblies in accordance with the present invention, which embodiments can include or not include any of other features described herein, the electronic assembly can comprise one or more voltage detectors, and/or one or more current detectors. Such voltage detector(s) (if included) can be positioned so as to detect voltage at any location(s) in an electronic assembly, e.g., voltage on either side of a surge protection assembly or surge protection module in accordance with the present invention, or voltage on either side of any other electronic component in the surge protection assembly or surge protection module. Similarly, current detector(s) (if included) can be positioned so as to detect current at any location(s) in a surge protection assembly or surge protection module in accordance with the present invention, e.g., current on a circuit that includes surge protection, or current on any circuit that is electrically in parallel with a circuit that includes surge protection. Detected voltage from any such voltage detector(s) and/or detected current from any such current detector(s) can be used for power and/or energy calculations with respect to the surge protection assembly or surge protection module and/or components thereof. Any detected voltage, current, energy and/or power values can be displayed by such voltage detector(s), current detector(s), energy calculator and/or power calculator, and/or can be transmitted (entirely through wires, through wires and wirelessly, or entirely wirelessly, in any of the ways, or combinations of the ways, discussed above in relation to surge protection status indication signals) to any other component within the surge protection assembly or surge protection module, within a junction box, or outside the surge protection assembly or surge protection module or junction box.

The present inventive subject matter now will be described more fully hereinafter with reference to the accompanying drawings, in which representative embodiments of the inventive subject matter are shown. However, the present inventive subject matter should not be construed as being limited to the specific features in the embodiments set forth herein. That is, every statement about an embodiment described herein is to be interpreted as being prefaced with “In this embodiment, . . . ”

Embodiments in accordance with the present inventive subject matter are described herein in detail in order to provide exact features of representative embodiments that are within the overall scope of the present inventive subject matter. The present inventive subject matter is not limited to such detail.

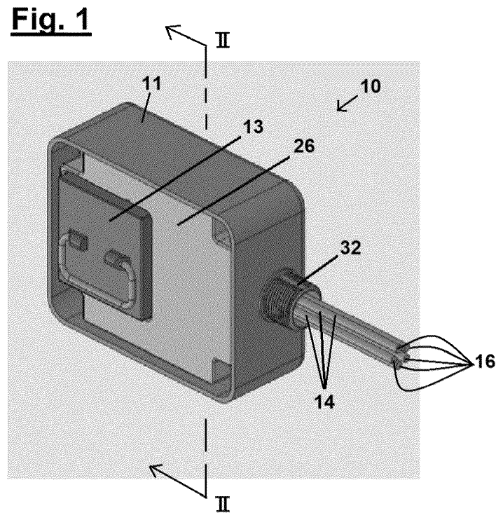

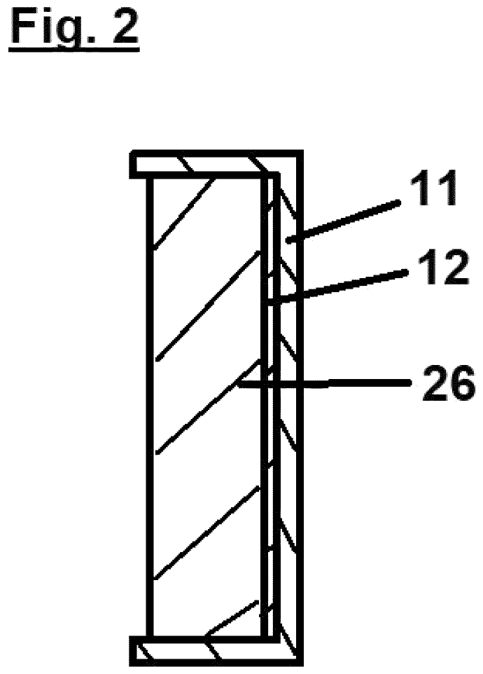

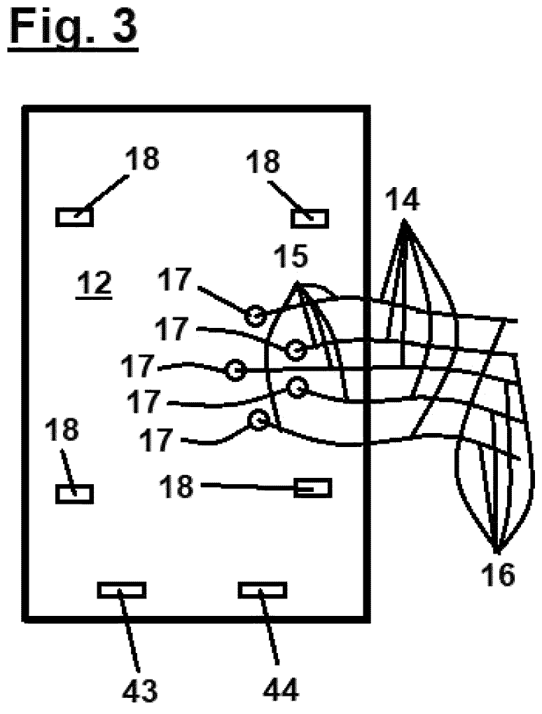

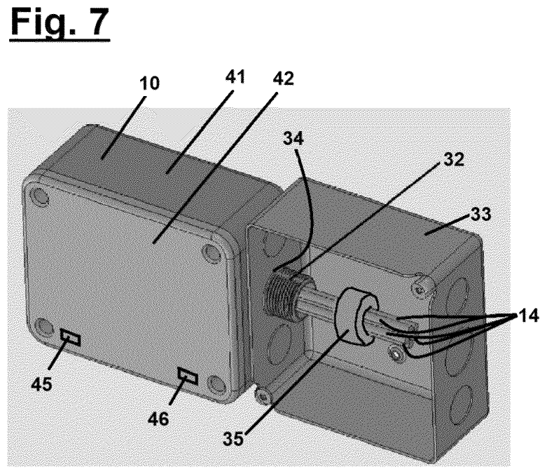

FIGS. 1, 2 and 4 are schematic views of a surge protection assembly 10 in accordance with the present invention, with its housing cover removed to facilitate explanation (a housing cover of a surge protection assembly, in the form of a second part 42 of a surge protection housing 11, is depicted in FIG. 7, discussed below). FIG. 1 is a first schematic perspective view of the surge protection device 10; FIG. 2 is a cross-sectional view taken along the plane II-II in FIG. 1. Referring to FIGS. 1 and 2, the surge protection assembly 10 comprises a surge protection assembly housing 11, a surge protection assembly circuit board 12, a surge protection module 13, an assembly housing insert 26, and conductive elements 14 (first, second, third, fourth and fifth conductive elements 14 of the surge protection assembly 10). FIG. 3 is a schematic plan view of the side of the surge protection assembly circuit board 12 closer to the assembly housing insert 26 (i.e., facing to the left in the orientation depicted in FIG. 2). Each of the first, second, third, fourth and fifth conductive elements 14 of the surge protection assembly has a respective conductive element first region 15 (see FIG. 3) and a respective conductive element second region 16 (FIG. 1). Each of the conductive element first regions 15 is inside the surge protection assembly housing 11 and each is electrically connected to a respective conductive element contact region 17 of the surge protection assembly circuit board 12. Each of the conductive element second regions 16 is outside the surge protection assembly housing 11.

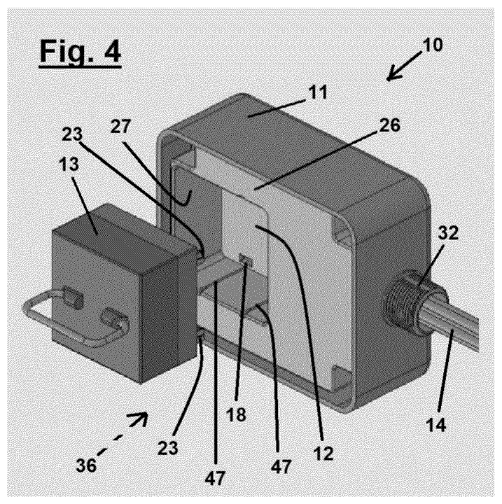

FIG. 4 is a second schematic perspective view of the surge protection device 10, FIG. 4 is similar to FIG. 1, except that in FIG. 4, the surge protection module 13 has been removed from a surge protection module-accommodating recess 27 in the assembly housing insert 26. In FIG. 1, a major portion of the surge protection module 13 is in the surge protection-module-accommodating recess 27.

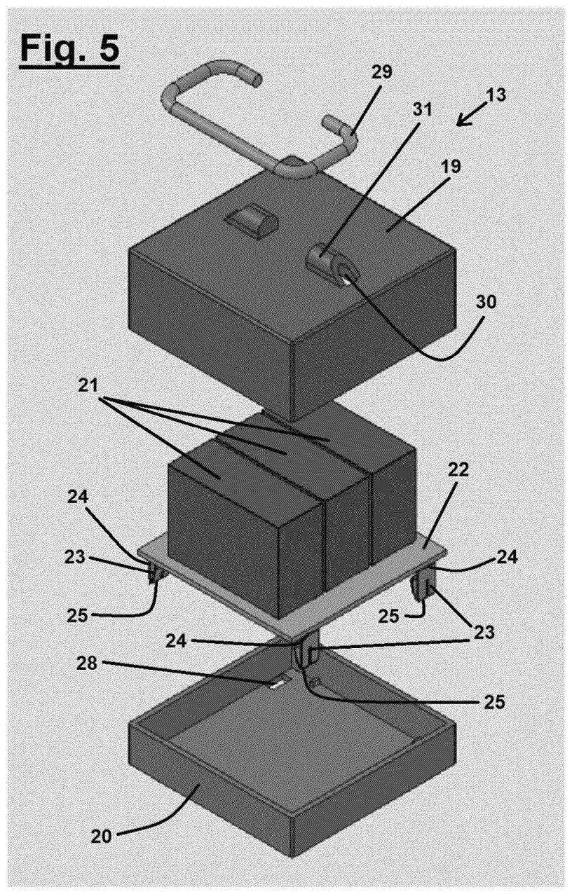

FIG. 5 is a schematic exploded perspective view of the surge protection module 13. The surge protection module comprises a surge protection module housing (in the form of a cover 19 and a base 20 that are attached to each other), three varistors 21 (each comprising a metal oxide varistor), a surge protection module circuit board 22, and four surge protection module terminals 23 (only three of which are visible in FIG. 5). The varistors 21 are each inside the surge protection module housing 19/20, and the varistors 21 are electrically connected to circuitry on the surge protection module circuit board 22.

Each of the surge protection module terminals 23 comprises a respective terminal first region 24 (adjacent to the surge protection module circuit board 22) and a respective terminal second region 25 (distal from the surge protection module circuit board 22). Each of the terminal first regions 24 is electrically connected to circuitry on the surge protection module circuit board 22.

The base 20 has four openings 28 (only one opening 28 is visible in FIG. 5), through each of which a respective one of the surge protection module terminals 23 extends, i.e., for each surge protection module terminal 23, the terminal first region 24 is inside the surge protection module housing 19/20, and the terminal second region 25 is outside the surge protection module housing 19/20; In this embodiment, all of the openings 28 are on a first side (the bottom side, in the base 20) of the surge protection module housing.

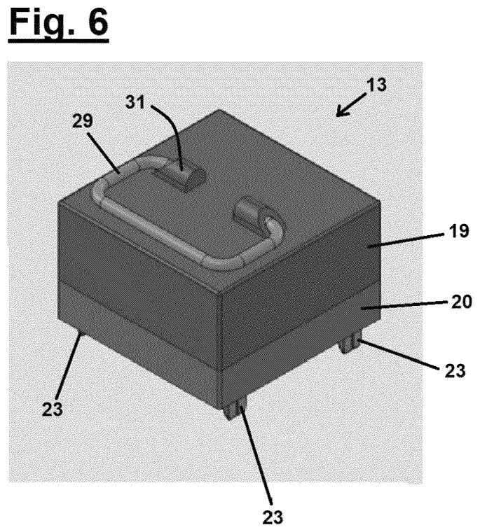

FIG. 6 is a schematic perspective (non-exploded) view of the surge protection module 13 shown in FIG. 5. Portions of three of the surge protection module terminals 23 are visible in FIG. 6, outside the surge protection module housing 19/20.

The surge protection module 13 also comprises a pull handle 29 which is pivotally attached to the cover 19 by portions of the pull handle 29 extending into spaces 30 (see FIG. 5) defined by pull handle retaining structures 31.

The surge protection assembly circuit board 12 also comprises first, second, third and fourth terminal connection regions 18 (see FIG. 3). The terminal connection regions 18 are in the form of recesses into which the surge protection module terminals 23 are pushed upon moving the surge protection module 13 from a disengaged arrangement (e.g., as in FIG. 4) to an engaged arrangement (e.g., as in FIG. 1). The surge protection module terminals 23 can be retracted out of the terminal connection regions 18 (recesses) by moving the surge protection module 13 from an engaged arrangement to a disengaged arrangement. The respective shapes of the terminal connection regions 18 and the surge protection module terminals 23 are such that excessive force is not required to move the surge protection module 13 from a disengaged arrangement to an engaged arrangement, or from an engaged arrangement to a disengaged arrangement, i.e., so that (as noted elsewhere) the surge protection module 13 is field-replaceable. As shown in FIG. 5, each surge protection module terminal 23 is generally U-shaped, whereby a free side of the U-shape is spring-loaded, and from its rest position can be flexed toward the side of the U-shape that is connected to the surge protection module circuit board 22 (such flexing resulting in the free side being biased toward its rest position), so that upon being inserted into a recess of a terminal connection regions 18, the free side is flexed toward the side of the U-shape that is connected to the surge protection module circuit board 22, whereby in an engaged arrangement, the surge protection module terminals 23 exert force against opposite sides of the recesses, such force serving to hold the surge protection module terminals 23 in place relative to the recesses, and ensuring secure electrical contact between the surge protection module terminals 23 and the terminal connection regions 18.

With the surge protection module 13 in the position relative to the rest of the surge protection assembly 10 as depicted in FIG. 1 (i.e., fully pressed into the surge protection module-accommodating recess 27), each of the surge protection module terminals 23 is in electrical contact with a respective one of the terminal connection regions 18, i.e., the surge protection is in an engaged arrangement. The surge protection module 13 can be removed from the surge protection module-accommodating recess 27 (and from the remainder of the surge protection assembly 10) by a normal person without any tools (i.e., it is field-replaceable) by pulling on the pull handle 29 by hand, whereby each of the surge protection module terminals 23 becomes electrically disconnected from the terminal connection regions 18.

Referring again to FIG. 1, the surge protection assembly housing 11 further comprises an external pipe thread 32 (integral with the surge protection assembly housing 11). The surge protection assembly can be securely mounted to a junction box by inserting the external pipe thread 32 through a knockout opening in the junction box, and then threading a pipe thread nut onto the external pipe thread 32. For example, FIG. 7 schematically depicts an arrangement in which the surge protection assembly 10 is ready to be securely mounted to a junction box 33 by inserting the external pipe thread 32 through a knockout opening 34 in the junction box 33, and then threading a pipe thread nut 35 onto the external pipe thread 32, prior to connecting the conductive elements 14 to appropriate wires (not shown) in the junction box 33. Using such an installation procedure, the surge protection assembly can be easily mounted alongside a junction box (e.g., a standard-size 2-gang electrical box) without the need to cut into any conduits, etc., to provide surge protection, e.g., for a load connected to wires in the 2-gang electrical box.

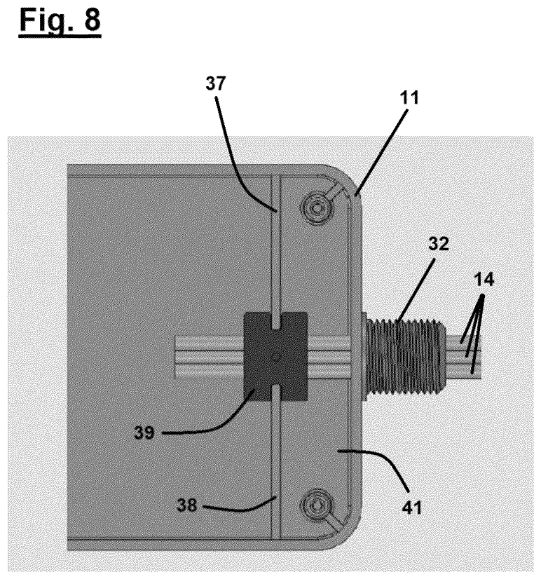

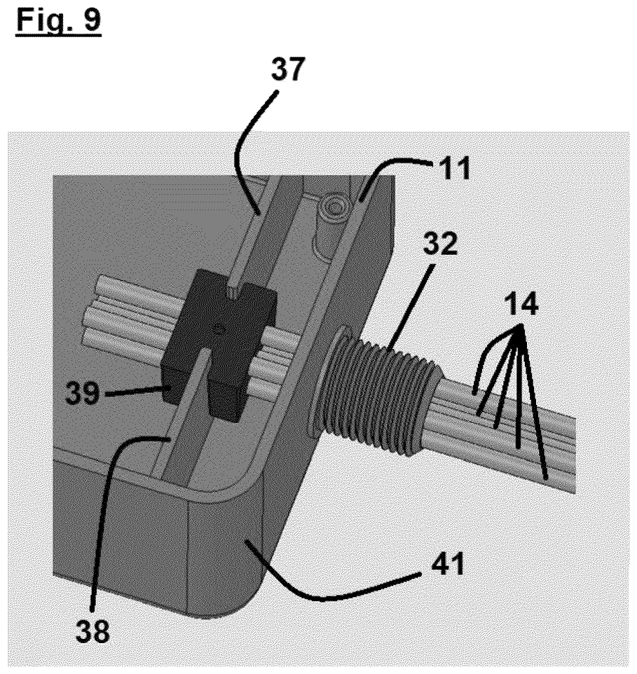

FIG. 8 is a schematic top view (i.e., a view in a direction 36 depicted in FIG. 4) of an interior of a right part of the surge protection assembly 10 depicted in FIGS. 1, 4 and 7 (i.e., a part of the surge protection assembly 10 closer to the external pipe thread 32), with the surge protection module 13, the assembly housing insert 26 and the surge protection assembly circuit board 12 removed so that a right part of the surge protection assembly housing 11 and portions of the conductive elements 14 are visible. FIG. 9 is a schematic perspective view that is similar to FIG. 8 (except that FIG. 9 is a perspective view, whereas FIG. 8 is a top view). As shown in FIGS. 8 and 9, the surge protection assembly housing 11 comprises a housing first rib 37 and a housing second rib 38, and the surge protection assembly further comprises a conductive elements support 39. Each of the conductive elements 14 extends through the conductive elements support 39 (e.g., by forming the conductive elements support 39 around the conductive elements 14, the conductive elements 14 extend through the conductive elements support 39; alternatively, the conductive elements support 39 could be formed from two or more pieces that include grooves to accommodate the conductive elements 14 and are connected so as to press on the conductive elements 14, or the conductive elements 14 could be forced through openings in which the conductive elements 14 tightly fit). The conductive elements support 39 can be resilient to at least some degree, such that it presses and holds the conductive elements 14 in place relative to the surge protection assembly housing 11 and relative to the conductive elements support 39. The conductive elements support 39 therefore provides strain relief, in that if one or more of the conductive elements 14 is pulled (e.g., a force is exerted on one of more of the conductive elements 14, tending to pull the conductive element(s) 14 away from the surge protection assembly circuit board 12), the conductive elements support 39 holds the conductive element(s) 14 in place, such that the force is not exerted on the surge protection assembly circuit board 12 (nor is the force transmitted to portions of the conductive elements 14 that are connected to the surge protection assembly circuit board 12).

In some embodiments, the surge protection assembly housing 11 comprises at least first and second parts, e.g., a first part 41 (see FIG. 7, and also FIGS. 8 and 9) and a second part 42 (e.g., a housing cover) (as seen in FIG. 7) that is attached to the first part 41 to provide an interior space in which the surge protection assembly circuit board 12, the surge protection module 13 and the assembly housing insert 26 are positioned.

Referring again to FIG. 3, the surge protection assembly 10 further comprises first and second indicator lights, in the form of a green LED 43 (which is illuminated when all of the varistors 21 are still in good working order) and a red LED 44 (which is illuminated when any one or more of the varistors 21 is spent or otherwise needs to be replaced), the green LED 43 and the red LED 44 mounted on the surge protection assembly circuit board 12, Referring to FIG. 7, the surge protection assembly 10 further comprises first and second light pipes 45 and 46. The first light pipe 45 carries light from the green LED 43 (when the green LED 43 is illuminated) to be emitted from the top of the housing cover (i.e., the second housing part 42), and the second light pipe 46 carries light from the red LED 44 (when the red LED 44 is illuminated) to be emitted from the top of the housing cover 42.

In some embodiments, the surge protection assembly housing 11 comprises a hinged door (e.g., in the second part 42), providing access to the interior of the surge protection assembly housing 11, facilitating removal and replacement of the surge protection module 13 (as well as access to the other items inside the surge protection assembly housing 11). In some embodiments, the hinged door comprises a latch that holds it closed until it is manipulated to open the hinged door, e.g., like a latch on an electrical service panel.

In some embodiments, a surge protection module (or modules) of one or more sizes that is/are different from the size of the surge protection module 13 shown in FIGS. 1 and 4-6, to accommodate a number (or numbers) of varistors that is/are different from the number of varistors in the surge protection module 13 shown in FIGS. 1 and 4-6 (e.g., a smaller surge protection module to accommodate the varistors where only two varistors are needed, or a larger surge protection module to accommodate a number of varistors that is greater than three), can be accommodated in a surge protection assembly, by using one or more respective assembly housing inserts that fit within the surge protection assembly housing and that include respective surge protection module-accommodating recesses that geometrically interface with the respective differently sized surge protection modules 13, such that in manufacturing different surge protection assemblies for use in different electrical arrangements, some of the components (e.g., the surge protection assembly housing 11) can be the same.

In some embodiments, different surge protection modules and different surge protection module-accommodating recesses can be keyed to one another, e.g., the surge protection modules can have protrusions (and/or ridges) and/or grooves that align with corresponding grooves and/or protrusions (and/or ridges) in or on the surge protection module-accommodating recesses to allow a surge protection module to be inserted into a surge protection module-accommodating recess only if the surge protection module is properly matched to the surge protection assembly housing 11 and conductive elements 14 in the surge protection assembly 10 in which the surge protection module-accommodating recess resides (e.g., different surge protection modules and different surge protection module-accommodating recesses have characteristic unique keys, so that if a person attempts to insert the wrong surge protection module into a surge protection module-accommodating recess, the keying arrangement will not permit the wrong surge protection module to be inserted into the surge protection module-accommodating recess, and will not permit the correct surge protection module to be inserted into the surge protection module-accommodating recess in an incorrect orientation), In FIG. 4, a pair of ribs 47 are shown on a side of the surge protection module-accommodating recess, and corresponding groove (not visible in FIG. 4) are provided on the side of the surge protection module.

In the embodiment depicted in FIGS. 1-9, and in other embodiments in accordance with the present invention, a number of advantages are provided. One advantage is that by providing plural varistors (e.g., two or three) in a single surge protection module, the surge protection assembly can independently protect two or more items or circuits (e.g., a first varistor can be electrically in parallel with a first load, a second varistor can be electrically in parallel with a second load, etc.), while the surge protection assembly is of a small size, e.g., similar to the size of a standard 2-gang junction box. In addition, the plural varistors are field-replaceable, and they are replaceable as a unit, i.e., by removing a surge protection module and inserting a replacement surge protection module, all of the varistors (i.e., two or more varistors) are replaced at once (also, in many instances, when one surge protection device is being replaced, all of the surge protection devices in the circuitry should be replaced; and likewise for the plural varistors in embodiments as depicted in FIGS. 1-9).

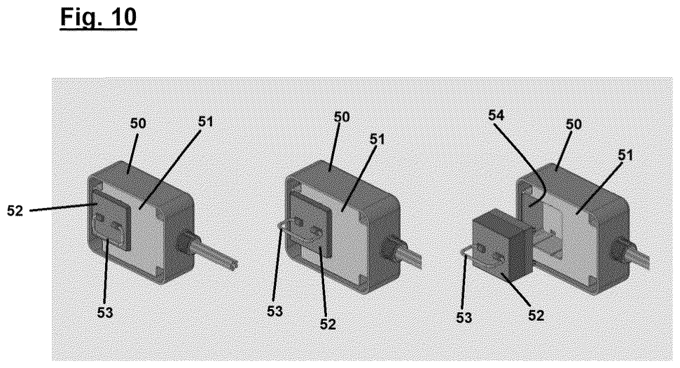

FIG. 10 schematically depicts a sequence (moving from the image in the far left, then to the image in the middle, and then to the image in the far right) in which a surge protection module is disengaged from a surge protection module-accommodating recess of a surge protection assembly. In the images, the surge protection assembly is depicted with its housing cover removed to facilitate explanation. In the image to the far left, a surge protection module 52 is accommodated in and geometrically interfaces (and is engaged) with a surge protection module-accommodating recess 54 in an assembly housing insert 51 that is positioned in a surge protection assembly housing 50. In the image to the far left, a pull handle 53 is in an orientation where it is substantially flat against the top surface of the surge protection module 52. In the image in the middle, the pull handle 53 has been pivoted so that it is substantially vertical, such that it can readily be gripped by a user. In the image to the far right, the surge protection module 52 has been disengaged and removed from the surge protection module-accommodating recess 54 by pulling on the pull handle 53.

Each component described herein can be a unitary one-piece structure. In some cases, if suitable, two or more structural parts of the devices described herein can be integrated, and/or a component can be provided in two or more parts (which are held together, if necessary). Similarly, any two or more functions can be conducted simultaneously, and/or any function can be conducted in a series of steps.

Furthermore, while certain embodiments of the present inventive subject matter have been illustrated with reference to specific combinations of elements and attributes, various other combinations may also be provided without departing from the teachings of the present inventive subject matter. Thus, the present inventive subject matter should not be construed as being limited to the particular exemplary embodiments described herein and illustrated in the Figures, but may also encompass combinations of elements and attributes of the various illustrated embodiments.

Based on the information provided in the present disclosure, many alterations and modifications may be made by those having ordinary skill in the art, given the benefit of the present disclosure, without departing from the spirit and scope of the inventive subject matter.

1. A surge protection assembly, comprising:
a surge protection assembly housing;
a surge protection assembly circuit board;
a surge protection module; and
at least first, second and third conductive elements of the surge protection assembly,
each of the first, second and third conductive elements of the surge protection assembly having a respective conductive element first region and a respective conductive element second region, each of the respective conductive element first regions is inside the surge protection assembly housing and is electrically connected to a respective conductive element contact region of the surge protection assembly circuit board, each of the respective conductive element second regions is outside the surge protection assembly housing,
the surge protection assembly circuit board comprises at least first, second and third terminal connection regions of the surge protection assembly circuit board,
the surge protection module comprising a surge protection module housing, a surge protection module circuit board, and at least three surge protection module terminals, the surge protection module configured to reduce resistance upon voltage in excess of a threshold voltage being applied, each of the surge protection module terminals comprising a respective terminal first region and a respective terminal second region, each of the terminal first regions is electrically connected to circuitry on the surge protection module circuit board, each of the terminal second regions is outside the surge protection module housing,
the surge protection module is movable as a unit, and is disengageable and re-engageable between an engaged arrangement and a disengaged arrangement,
in the engaged arrangement, each of the terminal second regions is electrically connected to a respective one of the terminal connection regions of the surge protection assembly circuit board, and
in the disengaged arrangement, each of the terminal second regions is electrically disconnected from each of the terminal connection regions of the surge protection assembly circuit board.

2. The surge protection assembly recited in claim 1, wherein the surge protection module terminals extend through openings in the surge protection module housing.

3. The surge protection assembly recited in claim 2, wherein all of the openings are on a first side of the surge protection module housing.

4. The surge protection assembly recited in claim 1, wherein the surge protection module circuit board is inside the surge protection module housing.

5-6. (canceled)

7. The surge protection assembly recited in claim 1, wherein:
the surge protection assembly further comprises an assembly housing insert,
the assembly housing insert is inside the surge protection assembly housing, and
the assembly housing insert comprises a surge protection module-accommodating recess that geometrically interfaces with the surge protection module.

8. The surge protection assembly recited in claim 1, wherein:
the surge protection assembly further comprises a conductive elements support,
the conductive elements support holds the at least first, second and third conductive elements of the surge protection assembly in place relative to the conductive elements support, and
the surge protection assembly housing and the conductive elements support are configured to hold the conductive elements support in place relative to the surge protection assembly housing.

9. (canceled)

10. The surge protection assembly recited in claim 1, wherein the surge protection assembly housing comprises an external pipe thread.

11-12. (canceled)

13. A surge protection module, comprising:
a surge protection module housing;
a surge protection module circuit board; and
at least three surge protection module terminals,
the surge protection module configured to reduce resistance upon voltage in excess of a threshold voltage being applied,
each of the surge protection module terminals comprising a respective terminal first region and a respective terminal second region, each of the terminal first regions is electrically connected to circuitry on the surge protection module circuit board, each of the terminal second regions is outside the surge protection module housing, and
the surge protection module is movable as a unit.

14. The surge protection module recited in claim 13, wherein the surge protection module is capable of being engaged with a surge protection assembly that has openings to receive at least respective portions of the surge protection module terminals and contacts to make electrical contact with the respective surge protection module terminals.

15. The surge protection module recited in claim 13, wherein the surge protection module terminals extend through openings in the surge protection module housing.

16. The surge protection module recited in claim 15, wherein all of the openings are on a first side of the surge protection module housing.

17. The surge protection module recited in claim 13, wherein the surge protection module circuit board is inside the surge protection module housing.

18-19. (canceled)

20. The surge protection module recited in claim 13, wherein the surge protection module housing comprises a cover and a base.

21. The surge protection module recited in claim 13, wherein the surge protection module comprises a pull handle pivotally attached to the surge protection module housing.

22. The surge protection module recited in claim 13, wherein the surge protection module comprises a pull handle pivotally attached to the surge protection module housing.

23-34. (canceled)

35. A method of installing a surge protection assembly to a plurality of circuitry conductive elements, the method comprising:
electrically connecting a plurality of conductive elements of a surge protection assembly to respective circuitry conductive elements in a junction box,
the surge protection assembly comprises a surge protection assembly housing, a surge protection assembly circuit board, a surge protection module, and the conductive elements of the surge protection assembly,
each of the conductive elements of the surge protection assembly having a respective conductive element first region and a respective conductive element second region, each of the respective conductive element first regions is inside the surge protection assembly housing and is electrically connected to a respective conductive element contact region of the surge protection assembly circuit board, each of the respective conductive element second regions is outside the surge protection assembly housing,
the surge protection assembly circuit board comprises at least first, second and third terminal connection regions of the surge protection assembly circuit board,
the surge protection module comprising a surge protection module housing, et a surge protection module circuit board, and at least three surge protection module terminals, the surge protection module configured to reduce resistance upon voltage in excess of a threshold voltage being applied, each of the surge protection module terminals comprising a respective terminal first region and a respective terminal second region, each of the terminal first regions is electrically connected to circuitry on the surge protection module circuit board, each of the terminal second regions is outside the surge protection module housing,
the surge protection module is movable as a unit, and is disengageable and re-engageable between an engaged arrangement and a disengaged arrangement,
in the engaged arrangement, each of the terminal second regions is electrically connected to a respective one of the terminal connection regions of the surge protection assembly circuit board, and
in the disengaged arrangement, each of the terminal second regions is electrically disconnected from each of the terminal connection regions of the surge protection assembly circuit board.

36-38. (canceled)

39. The method recited in claim 35, wherein:
the surge protection assembly housing comprises an external pipe thread, and
the method further comprises threading a pipe thread nut on the external pipe thread of the surge protection assembly housing.

40. The surge protection assembly recited in claim 1, wherein the surge protection module comprises at least a first varistor.

41. The surge protection assembly recited in claim 40, wherein the first varistor is inside the surge protection module housing.

42. The surge protection module recited in claim 13, wherein the surge protection module comprises at least a first varistor.
